(19) United States
(12) Patent Application Publication
(10) Pub. No.: US 2006/0156305 A1
(43) Pub. Date: Jul. 13, 2006

(54) Multiple task access to an ordered data structure

(76) Inventor: Jaroslav Delapedraja, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,253

(22) Filed: Dec. 21, 2004

(51) Int. Cl. G06F 9/52

(52) U.S. Cl. 718/102

(57) ABSTRACT

A system and method is provided for efficient access to a data structure by multiple tasks in a computing environment. The data structure can include an ordered arrangement of elements. One operation of the method can include associating a spinlock with the data structure. Another operation may include defining a plurality of traversal iterators, each having a read pointer pointing to an element within the data structure. The traversal iterators can each be associated with a reader task. A further operation can include traversing the data structure using a reader task. The reader task traverses the data structure by using the read pointer of its associated traversal iterator while holding the spinlock. An additional operation may include deleting a selected element from the data structure using a writer task. The writer task can adjust the read pointer of traversal iterators whose read pointers point to the selected element to be deleted while holding the spinlock.

### FIELD OF THE INVENTION

The present invention relates generally to sharing data structures in a computing environment.

### BACKGROUND

Modern computing systems often make use of multitasking, multiprocessing, or multithreading. For example, a single central processing unit (CPU) may simulate concurrent execution of multiple tasks (sometimes referred to as threads) by switching between the different tasks to provide a fair allocation of CPU time to each task. Multiprocessing systems make use of multiple CPUs and each CPU can execute an assigned task. Both of these techniques may be used in combination in some systems.

In a multitasking system (used herein to refer to multitasking, multiprocessing, and multithreading systems), the multiple tasks may require access to common resources, such as a data structure. For example, tasks running under an operating system may require access to a data structure that has information about the operating system's file system.

Care must be taken to avoid conflicts between multiple tasks accessing the same data structure simultaneously. For example, if one task writes to the data structure while another task is reading from the data structure, then the results can be unpredictable. When multiple tasks attempt to simultaneously modify the data, this may result in the data becoming corrupted. For example, if one task deletes a data structure element that another task holds a pointer to, the pointer becomes invalid (a so-called “dangling pointer”).

To avoid such conflicts, various locks can be implemented to ensure that only a single task accesses the data structure at one time. For example, a mutual exclusion (“mutex”) lock will allow one task to access the data structure at a time. A first task that desires to access the data structure first obtains the mutex lock. When a second task is currently using the data structure, the first task waits until the second task has released the mutex lock. Waiting tasks may either be suspended (allowing other tasks to execute) or spinning (repeatedly checking until the lock becomes available). If the second task takes a long time to release the lock, the first task may be waiting for an extended time period. Various other kinds of locks are also known.

Locking of a data structure by an accessing task can degrade the performance of a computing system when the data structure is shared by many tasks. Because just one task at a time can access the data structure, tasks may spend long time intervals waiting for each other when the data structure is heavily used. Waiting times can be exacerbated when the data structure is large (e.g., a long linked list) and tasks take a long time to traverse the data structure. For example, a low priority task may begin a traverse of the data structure, and then be preempted by a higher priority task. If the lower priority task wishes to traverse the data structure, it waits until the higher priority task is complete. Unfortunately, the low priority task may take a long time to complete, in part because it is preempted by other higher priority tasks. If many tasks wish to traverse a large data structure, locking the data structure during the traverse may thus result in unacceptable performance of the system.

### SUMMARY

The invention includes a system and method for providing efficient access to a data structure by multiple tasks in a computing environment. The data structure can include an ordered arrangement of elements. One operation of the method can include associating a spinlock with the data structure. Another operation may include defining a plurality of traversal iterators, each having a read pointer pointing to an element within the data structure. The traversal iterators can each be associated with a reader task. A further operation can include traversing the data structure using a reader task. The reader task traverses the data structure by using the read pointer of its associated traversal iterator while holding the spinlock. An additional operation may include deleting a selected element from the data structure using a writer task. The writer task adjusts the read pointer of traversal iterators whose read pointers point to the selected element to be deleted while holding the spinlock.

### BRIEF DESCRIPTION OF THE DRAWINGS

FIG. 1 is a block diagram of a system for providing efficient shared access to a data structure in accordance with one embodiment;

FIGS. 2a-2b are illustrations of deleting a selected element from a data structure in accordance with one embodiment;

FIGS. 3a-3b are illustrations of deleting a selected element from a data structure in accordance with another embodiment;

FIG. 4 is a block diagram of a system for providing efficient shared access to a data structure, in accordance with another embodiment;

FIG. 5 is flow chart of a method for providing efficient access to a data structure by multiple tasks, in accordance with an embodiment; and

FIG. 6 is a flow chart of another method for providing efficient access to a data structure by multiple tasks, in accordance with an embodiment.

### DETAILED DESCRIPTION

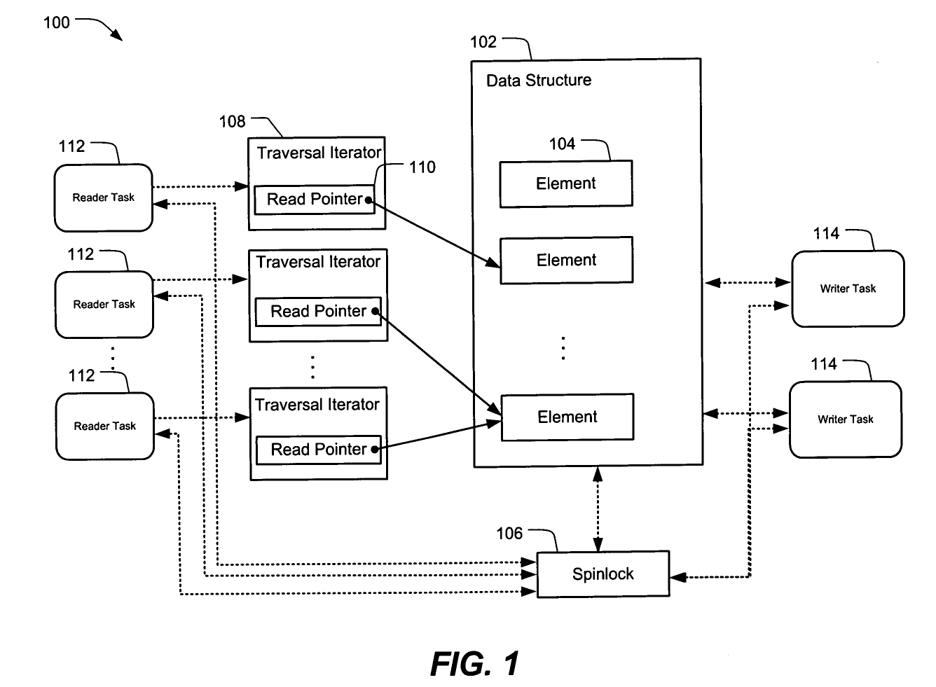

FIG. 1 illustrates a system 100 for providing efficient shared access to a data structure in accordance with an embodiment. Several different tasks, such as reader tasks 112 and one or more writer tasks 114 may access the data structure 102. The data structure 102 includes an ordered arrangement of elements 104. By ordered is meant that the data structure can be traversed by advancing from one element to a next element using some form of a pointer structure. The system may be implemented, for example, within a computer for an operating system or an application on an operating system. In addition, the data structure may be a linked list, such as a single or double linked list. Alternately, the elements may be ordered as a tree or in two or three dimensional linked lists, as a graph, or as any arbitrary data structure supporting ordered traversal.

A spinlock 106 is associated with the data structure 102. A spinlock is a mechanism which allows a single task to hold the spinlock at a time. If a task attempts to obtain a spinlock already held by another task, it will execute a wait loop until the spinlock is released. Once a task has obtained the spinlock, it is assured that no other task has the spinlock. Various ways of implementing a spinlock are known in the art. For example, functions to create, hold, and release a spinlock are provided by some operating systems. The spinlock can be implemented by using a flag (or semaphore) that is accessed through atomic functions. Alternatively, the lock can be implemented with a mutex lock where the locked processes are suspended or put to sleep.

The reader tasks 112 access the data structure 102 using traversal iterators 108. Each reader task has an associated traversal iterator. The traversal iterators include a read pointer 110 which points at an element of the data structure. Hence, the reader tasks can traverse the data structure by advancing the read pointer from element to element 104. The reader task will hold the spinlock 106 while updating its read pointer. For example, to traverse the data structure, the reader task may perform the following operations to advance one element in the data structure:
obtain the spinlock associated with the data structure,
advance the read pointer associated with the reader task's iterator to point to a next element of the data structure,
visit the next element of the data structure,
release the spinlock.

The reader task helps to avoid corruption of the read pointer by holding the spinlock while updating the read pointer. Furthermore, because the reader task releases the spinlock after visiting each element during a long traverse, the reader task limits the amount of blocking of other tasks from accessing the data structure. For example, multiple reader tasks can simultaneously traverse the data structure, each taking turns holding the spinlock while advancing their read pointers and visiting elements of the data structure. Accordingly, efficiency in sharing the data structure can be enhanced relative to an approach where the spinlock is held for the entire time a reader task is traversing the data structure.

Of course, by releasing the spinlock 106 between visiting elements of the data structure 102, a reader task 112 may be interrupted by the writer task 114 wishing to make changes to the data structure. For example, the writer task may delete an element 104 from the data structure, including the element to which a reader task has its traversal iterator read pointer currently pointing. Hence, the writer task will delete a selected element of the data structure by holding the spinlock while adjusting the read pointer of those traversal iterators whose read pointers point to the selected element. For example, the writer task may perform the following operations:
obtain the spinlock associated with the data structure,
modify the read pointers of traversal iterators whose pointers point to the selected element,
remove the selected element,
release the spinlock.

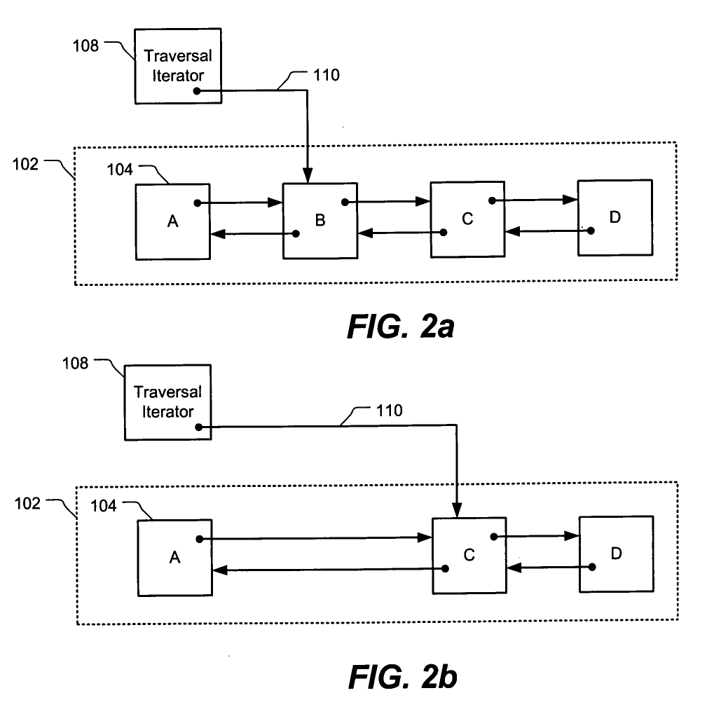

By modifying the read pointers that point to the selected element that is to be deleted, dangling pointers can be avoided. For example, FIGS. 2a and b illustrate an example of deleting a selected element from a data structure, in accordance with an embodiment. The data structure 102 is a doubly linked list of elements 104, having elements A, B, C, and D (although a singly linked list or other ordered data structure can also be used, as discussed above). FIG. 2a shows the data structure before the selected element is deleted. A traversal iterator 108 is associated with a reader task that is traversing the data structure and the traversal iterator has a read pointer 110 currently pointing to element B. FIG. 2b shows the data structure after element B has been deleted. When the writer task deletes element B, the read pointer is modified. For example, as shown here the read pointer is advanced to the next element, element C. Of course, alternate approaches to modifying the read pointer may be used in other implementations. For example, the read pointer might be backed up to the previous element in the data structure. If the read pointer is pointing to the last element in the data structure (in this example, element D), and that element is to be deleted, the read pointer can be set to null. In such a case, the reader task will understand that a null read pointer indicates that the traverse has been completed.

New elements can also be inserted in the data structure by the writer task. While inserting a new element, the writer task will hold the spinlock. For example, where the data structure is a linked list, holding the spinlock helps to ensure that no reader task (or another writer task) is trying to use the pointers or links while they are being adjusted by the writer task. Various ways of inserting an element into a linked list are known in the art.

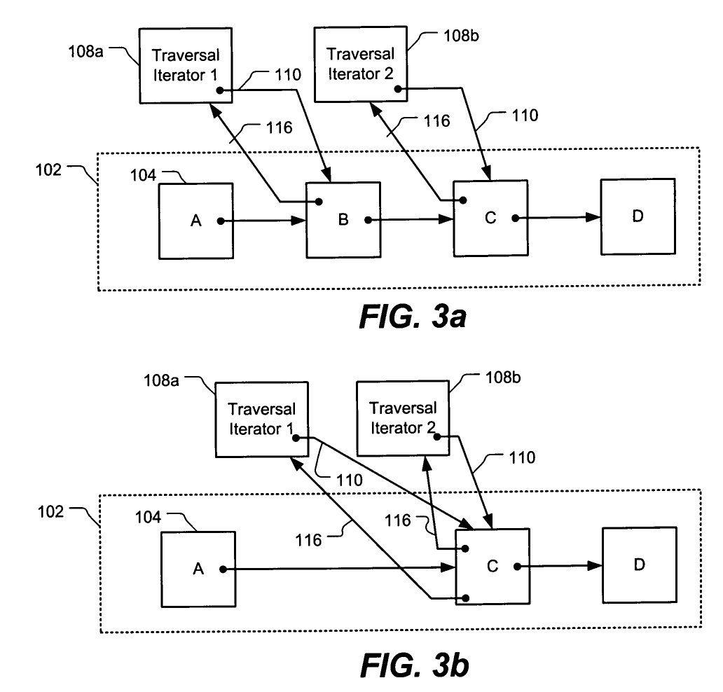

In accordance with another embodiment, performance of the system can be further enhanced by including a back pointer in the data structure elements that points back to the traversal iterator (or iterators). For example, FIGS. 3a and 3b illustrate an example of deleting a selected element from a data structure, in accordance with one embodiment. The data structure 102 is a singly linked list of elements 104, having elements A, B, C, and D. Two reader tasks have associated traversal iterators 108a, 108b. The list elements include a back pointer 116, which points back to the traversal iterator(s) pointing to the element. FIG. 3a shows the iterators and data structure before the writer task performs the deletion of element B, and FIG. 3b shows the same after the deletion of element B.

The writer task uses the back pointer of the selected element (element B) being deleted to locate the traversal iterator(s) which point to the selected element. Those read pointers are modified by the writer task. For example, here element B is selected to be deleted, so the writer task follows element B's back pointer to traversal iterator 108a and advances the read pointer to point to the next element, element C. More specifically, the operations performed by the writer task may include the following:
obtain the spinlock associated with the data structure,
modify the read pointer of traversal iterators pointed to by the back pointer of the selected element,
remove the selected element,
release the spinlock.

In further detail, to modify the read pointers, the writer task may perform the following operations:
advance the read pointer to point to the next element,
set the back pointer of the next element to point to the traversal iterator.

As discussed above, if there is no next element after the selected element being deleted, any read pointers that point to the selected element may be set to null, which will be understood by reader tasks as indicating the traversal is complete.

When back pointers are included, reader tasks may include additional steps to update the back pointer. For example, to traverse the data structure, a reader task may perform the following operations:
obtain the spinlock associated with the data structure,
clear the back pointer of the current element (pointed to by the read pointer of the reader task's iterator),
advance the read pointer of the reader task's associated traversal iterator to point to a next element,
set the back pointer of the next element to point to the traversal iterator
visit the next element,
release the spinlock.

Various aspects of the back pointer warrant further detailed discussion. As can be seen from FIG. 3b, an element 104 may have multiple back pointers 116 pointing to traversal iterators 108 associated with different reader tasks. This can be accommodated in a variety of ways as will occur to one of skill in the art. For example, the element may have an array of back pointers. Alternately, a back pointer may be implemented as a data structure which includes a link pointer, which can point to a next back pointer. This may allow the element to have a linked list of back pointers which can grow and shrink when back pointers are added and deleted. Clearing the back pointer can include removing a back pointer from the array, or setting a back pointer (or back pointer link) to null.

Inclusion of back pointers can provide enhanced efficiency when deleting an element from the data structure. For example, the writer task can directly look up which traversal iterators are pointing to an element by following the element's back pointer(s) instead of examining all of the traversal iterators. This efficiency benefit increases as more reader tasks and associated traversal iterators are included in the system. Although there is some added overhead associated with maintaining the back pointers, this overhead is generally outweighed by the improved efficiency.

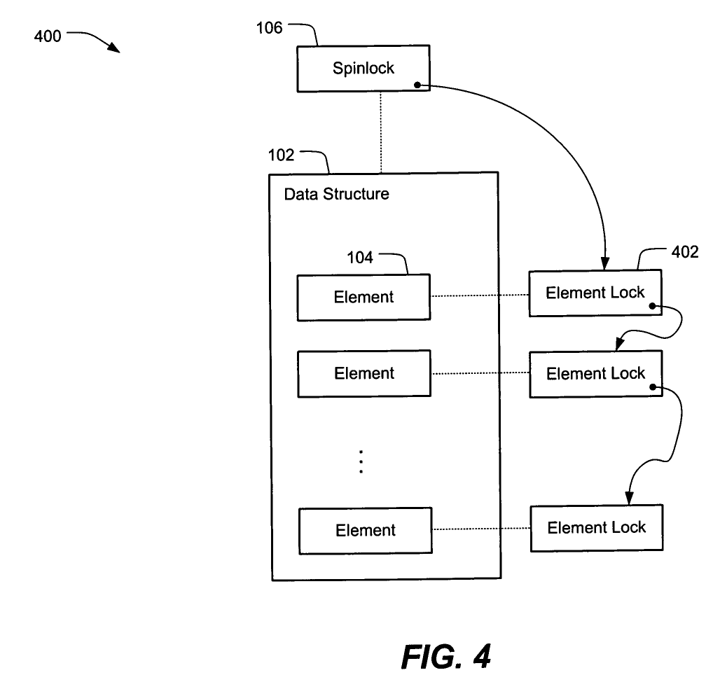

In accordance with another embodiment, performance can be further enhanced by including per element locks. FIG. 4 illustrates a system 400 for providing efficient shared access to a data structure in accordance with another embodiment. As described above, the data structure 102 can include an ordered arrangement of elements. The system includes a spinlock 106 associated with the data structure, and a plurality of element locks 402. Each element lock is associated with an element 104 of the data structure. The reader and writer tasks are further configured to hold the element locks while reading and deleting an element.

For example, to access an element of the data structure, the reader task may include the following operations:
obtain the spinlock associated with the data structure,
advance the read pointer (of the reader task's associated transversal iterator) to point to a next element of the data structure,
lock the element lock associated with the next element,
release the spinlock,
visit the next element,
unlock the element lock.

The use of per element locks allows the reader task to release the spinlock while visiting the element, allowing other reader tasks to access the spinlock. Hence, even while visiting an element of the data structure, other reader tasks can continue with their traverses (unless, they wish to access the same element, in which case they will wait until the element lock becomes unlocked). Shared access to the data structure is thus accordingly enhanced.

The writer task also obtains the element lock to delete an element. Hence, the reader tasks operations may include:
obtain the spinlock associated with the data structure,
lock the element lock associated with the selected element,
modify the read pointer of traversal iterators whose read pointers point to the selected element,
remove the selected element and its element lock,
release the spinlock.

Various implementation options for the element locks will occur to one of skill in the art. For example, the element lock may also be implemented using a spinlock. Alternately, the element locks may be a flag which is set to lock the element and cleared to unlock the element. A flag may be used for the element lock since it is protected by the spinlock associated with the data structure. Additionally, element locks may optionally be dynamically allocated and associated with the elements as needed, and deleted when no longer needed.

In another example embodiment, the element locks or holding node operation can use a reference counter that allows multiple reader processes to put a hold on the node being visited. The writer processes then wait for the reference count to reach zero before actually deleting the node. Additionally, the deletion operation may even be configured to fail when the reference count is not zero. In this way, the reference counters are another implementation option for the element locks. For example, this embodiment may be used in an operating system's file system.

Another similar way of looking at this counter model is that instead of using a spinlock or mutex, the per-element lock can be a reader/writer lock. Reader processes can obtain the per-element lock in read mode, and the writer process can acquire it in exclusive write mode in order to delete the node. The implication of the reference counter or reader/writer model is that multiple reader processes are allowed to visit each node at the same time but multiple writer processes are not. This is an embodiment that not all implementations will want to use because the basic per-element lock configuration is a better approach for many applications. However, the reference counter model can leverage additional opportunities for parallelism within the nodes (and additional synchronization with locks).

In accordance with another embodiment, both per element locks and back pointers may be used. In such a case, a reader task can traverse the data structure by performing the following operations:
obtain the spinlock associated with the data structure,
clear the back pointer of the current element,
advance the read pointer to point to a next element,
set the back pointer of the current element to point to the reader task's traversal iterator,
lock the element,
release the spinlock,
visit the element
unlock the spinlock.

The writer task can delete a selected element by performing the following operations:
obtain the spinlock associated with the data structure,
lock the selected element,
modify the read pointer of traversal iterators pointed to by the back pointer of the selected element,
remove the selected element and its associated lock,
release the spinlock.

The step of modifying the read pointer can include advancing the read pointer to point to a next element, and setting the next element's back pointer to point to the traversal iterator.

Returning to a discussion of the traversal iterators, the traversal iterators may optionally be linked into a traversal iterator list which is associated with the data structure or associated with the spinlock. For example, a reader task desiring access to the data structure can create a new traversal iterator by holding the spinlock while inserting the new traversal iterator into the traversal iterator list. By including the traversal iterators in a list, the writer task can traverse the traversal iterator list, checking each of the read pointers to determine which are pointing to a selected element.

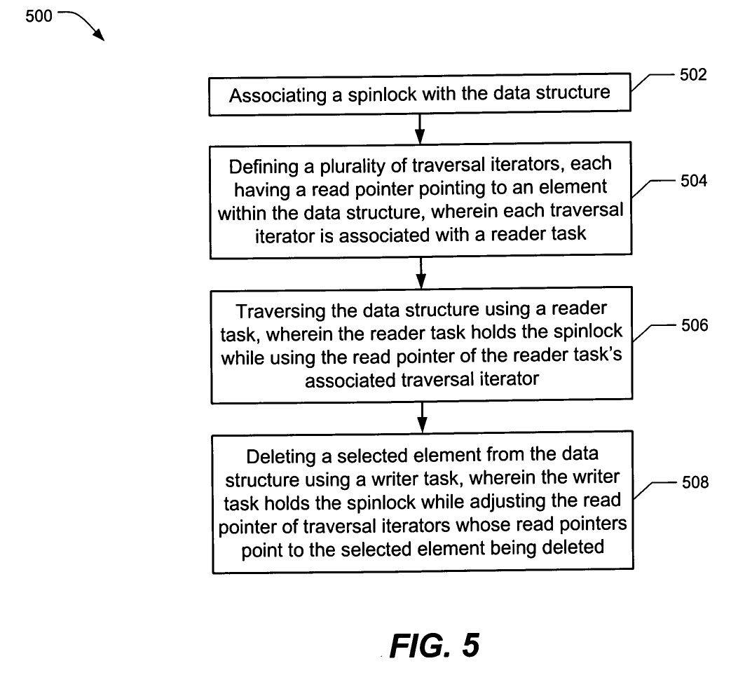

Two exemplary method embodiments will now be described. A first method 500 for providing efficient access to a data structure by multiple tasks is illustrated in FIG. 5. The method may include associating a spinlock with the data structure 502. Various ways of associating the spinlock with the data structure will occur to one of skill in the art. For example, the spinlock may be linked to the data structure, or vice versa. Alternately, tasks desiring to access the data structure may be aware of the associated spinlock. Various implementations of a spinlock are known in the art as discussed previously.

The method may also include defining a plurality of traversal iterators, each traversal iterator associated with a reader task 504. Each traversal iterator includes a read pointer, which points to an element within the data structure. The traversal iterators may optionally be linked to the data structure or the spinlock, for example in a linked list, as discussed previously. Various implementations of an iterator are known in the art and discussed further above.

The method may also include traversing the data structure using a reader task 506. The reader task holds the spinlock while using the read pointer of the reader tasks' associated traversal iterator. As discussed above, the spinlock permits access by a single task at one time, helping to avoid dangling pointers.

Finally, the method may also include deleting a selected element from the data structure using a writer task 508. The writer task holds the spinlock while adjusting the read pointers of traversal iterators whose read pointers point to the selected element being deleted. As discussed above, by adjusting the read pointers of traversal iterators pointing to the selected element to be deleted, the reader tasks will be able to continue with their traverses of the data structure.

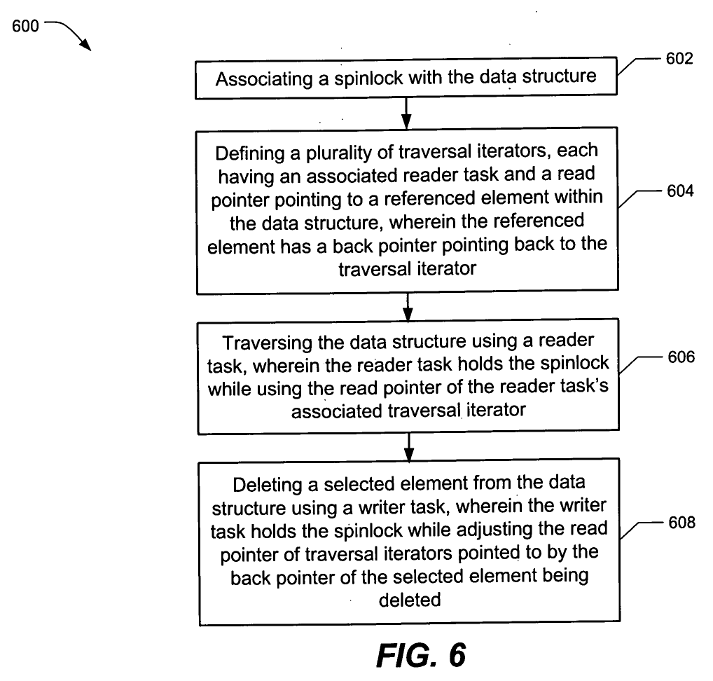

A second method 600 for providing efficient access to a data structure by multiple tasks is illustrated in FIG. 6 in accordance with another exemplary embodiment. The method may include associating a spinlock with the data structure 602, as described previously. The method may also include defining a plurality of traversal iterators, each associated with a reader task 604. The traversal iterators include a read pointer, which points to a referenced element within the data structure. The referenced element within the data structure also has a back pointer which points back to the traversal iterator(s) referencing it as discussed previously.

The method can also include traversing the data structure using a reader task 606, similarly as discussed above. Finally, the method can include deleting a selected element from the data structure using a writer task 608. The writer task holds the spinlock while adjusting the read pointer of traversal iterators pointed to by the back pointer of the selected element being deleted. As discussed above, the efficiency of the data structure access can be enhanced, since the writer task can follow the back pointer to those traversal iterators that can have their read pointers adjusted, rather than searching through all of the traversal iterators to see which are pointing to the selected node to be deleted.

The various embodiments as described above can be implemented in a variety of forms, including for example software. As such, a computer usable medium, including flash memory, magnetic disk, compact disk, digital video disk, etc. may contain computer readable program code to implement the foregoing embodiments. Computer readable code can include executable machine language and/or source code in a high level language such as C or C++.

From the foregoing, it will be appreciated that the various embodiments provide efficient shared access to a data structure. Multiple reader tasks can concurrently traverse a data structure, and hold a spinlock associated with the data structure briefly upon visiting each element of the data structure. Hence, the system efficiency is enhanced since reader tasks do not wait for each other to complete their respective traverses. Additionally, a writer task can delete elements from (or add elements to) the data structure while the reader tasks are traversing the data structure. When deleting an element, the writer task adjusts read pointers pointing to the node being deleted so as to avoid the creation of dangling pointers. Hence, changes to the data structure can be made without disrupting reader tasks traversals. The performance of the system can thus be significantly enhanced under a variety of conditions, including when many reader tasks desire access to the same data structures and when traversing a data structure takes a long period of time.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for providing efficient access to a data structure having an ordered arrangement of elements by multiple tasks in a computing environment, comprising:
associating a spinlock with the data structure;
defining a plurality of traversal iterators, each having a read pointer pointing to an element within the data structure, wherein each traversal iterator is associated with a reader task;
traversing the data structure using the reader task, wherein the reader task holds the spinlock while using the read pointer of the reader task's associated traversal iterator; and
deleting a selected element from the data structure using a writer task, wherein the writer task holds the spinlock while adjusting the read pointer of traversal iterators whose read pointers point to the selected element being deleted.

2. The method of claim 1 wherein modifying the read pointer further comprises advancing the read pointer to point to a next element of the data structure.

3. The method of claim 1 wherein modifying the read pointer further comprises setting the read pointer to a previous element of the data structure.

4. The method of claim 1 wherein traversing the data structure further comprises:
obtaining the spinlock for the reader task;
advancing the read pointer of the reader task's associated traversal iterator to point to a next element of the data structure;
visiting the next element using the reader tasks; and
releasing the spinlock held by the reader task.

5. The method of claim 1 wherein deleting a selected element further comprises:
obtaining the spinlock for the writer task;
modifying the read pointer of traversal iterators whose read pointers point to the selected element that will be deleted;
removing the selected element; and
releasing the spinlock held by the writer task.

6. The method of claim 1 further comprising establishing a plurality of element locks, each element lock associated with an element of the data structure.

7. The method of claim 6 wherein traversing the data structure further comprises:
obtaining the spinlock for the reader task;
advancing the read pointer of the reader task's associated traversal iterator to point to a next element of the data structure;
locking the element lock associated with the next element, releasing the spinlock held by the reader task;
visiting the element using the reader task; and
unlocking the element lock.

8. The method of claim 6 wherein deleting a selected element further comprises:
obtaining the spinlock for the writer task;
locking the element lock associated with the selected element to be deleted;
modifying the read pointer of traversal iterators whose read pointers point to the selected element to be deleted;
removing the selected element and its associated element lock; and
releasing the spinlock held by the writer task.

9. The method of claim 1 further comprising linking the plurality of traversal iterators into a traversal iterator list, wherein the traversal iterator list is associated with the spinlock.

10. The method of claim 9 further comprising creating a new traversal iterator using the reader task, wherein the reader task holds the spinlock while inserting the new traversal iterator into the traversal iterator list.

11. The method of claim 1 further comprising adding a new element into the data structure using the writer task, wherein the writer task holds the spinlock while inserting the new element into the data structure.

12. The method of claim 1 wherein the data structure is a linked list of elements.

13. A method for providing efficient access to a data structure having an ordered arrangement of elements by multiple tasks in a computing environment, comprising:
associating a spinlock with the data structure;
defining a plurality of traversal iterators, each having an associated reader task and a read pointer pointing to a referenced element in the data structure, wherein the referenced element has a back pointer pointing back to the traversal iterator;
traversing the data structure using a reader task, wherein the reader task holds the spinlock while using the read pointer of its associated traversal iterator; and
deleting a selected element from the data structure using a writer task, wherein the writer task holds the spinlock while adjusting the read pointer of traversal iterators pointed to by the back pointer of the selected element being deleted.

14. The method of claim 13 wherein traversing the data structure further comprises:
obtaining the spinlock for the reader task;
advancing the read pointer of the reader task's associated traversal iterator to point to a next element of the data structure;
visiting the next element; and
releasing the spinlock held by the reader task.

15. The method of claim 14 wherein traversing the data structure further comprises:
clearing the back pointer of the next element pointed to by the traversal iterator read pointer; and
setting the back pointer of the next element to point to the traversal iterator.

16. The method of claim 15 wherein clearing the back pointer further comprises setting the back pointer to null.

17. The method of claim 13 wherein deleting a selected element further comprises:
obtaining the spinlock;
advancing the read pointer of traversal iterators pointed to by the back pointer of the selected element;
removing the selected element; and
releasing the spinlock.

18. The method of claim 17 wherein advancing the read pointer further comprises setting the back pointer of the next element to point to the traversal iterators pointed to by the back pointer of the selected element.

19. The method of claim 17 wherein advancing the read pointer further comprises setting the read pointer to null when there is no next element of the data structure.

20. The method of claim 13 further comprising establishing a plurality of element locks, each element lock associated with an element of the data structure wherein the element lock corresponding to a visited element of the data structure is used by the reader task when visiting the visited element, and the element lock corresponding to the selected element of the data structure is used by the writer task when deleting the selected element.

21. The method of claim 20 wherein traversing the data structure further comprises:
obtaining the spinlock for the reader task;
advancing the read pointer of the reader task's traversal iterator to point to a next element of the data structure;
locking the element lock associated with the next element, releasing the spinlock held by the reader task;
visiting the element using the reader task; and
unlocking the element lock.

22. The method of claim 20 wherein deleting a selected element further comprises:
obtaining the spinlock for the writer task;
locking the element lock associated with the selected element to be deleted;
modifying the read pointer of traversal iterators pointed to by the back pointer of the selected element to be deleted;
removing the selected element and its associated element lock; and
releasing the spinlock held by the writer task.

23. The method of claim 13 further comprising linking the plurality of traversal iterators into a traversal iterator list, wherein the traversal iterator list is associated with the spinlock.

24. The method of claim 23 further comprising creating a new traversal iterator using a reader task, wherein the reader task holds the spinlock while inserting the new traversal iterator into the traversal iterator list.

25. The method of claim 13 further comprising adding a new element into the data structure using a writer task, wherein the writer task holds the spinlock while inserting the new element into the data structure.

26. The method of claim 13 wherein the data structure is a linked list of elements.

27. A system for providing efficient shared access to a data structure having an ordered arrangement of elements, comprising:
a spinlock associated with the data structure;
a plurality of traversal iterators, each traversal iterator having a read pointer configured to point to an element within the data structure;
a reader task associated with each of the plurality of traversal iterators, wherein the reader task is configured to traverse the data structure by holding the spinlock while advancing the read pointer of its associated traversal iterator; and
a writer task configured to delete a selected element of the data structure by holding the spinlock while adjusting the read pointer of those traversal iterators whose read pointers point to the selected element.

28. The system of claim 27 further comprising a plurality of element locks, each element lock associated with an element of the data structure wherein the reader task is further configured to lock the element lock associated with a current element of the data structure while reading the current element, and the writer task is further configured to hold the element lock associated with the selected element of the data structure while deleting the selected element.

29. A system for providing efficient shared access to a data structure having an ordered arrangement of elements, comprising:
a spinlock associated with the data structure;
a plurality of traversal iterators, each traversal iterator having a read pointer configured to point to a referenced element within the data structure;
a back pointer in the referenced element that is configured to point back to the traversal iterator;
a reader task associated with one of the plurality of traversal iterators, wherein the reader task is configured to traverse the data structure by holding the spinlock while advancing the read pointer of its associated traversal iterator; and
a writer task configured to delete a selected element of the data structure by adjusting the read pointer of traversal iterators pointed to by the selected element's back pointer.

30. The system of claim 29 further comprising a plurality of element locks, each element lock associated with an element of the data structure wherein the reader task is further configured to hold the element lock associated with a current element of the data structure while reading the current element, and the writer task is further configured to hold the element lock associated with the selected element of the data structure while deleting the selected element.

31. A system for providing efficient shared access to a data structure having an ordered arrangement of elements, comprising:
a spinlock means for locking the data structure by a task to prevent access by competing tasks;
a plurality of iterator means for pointing to an element within the data structure;
a plurality of element locking means for locking a selected element of the data structure while reading the current element and while deleting the selected element;
a plurality of reader means for reading the element within the data structure, each reader means associated with an iterator means wherein the reader means is configured to use the spinlock means to lock the data structure while accessing the data structure using the iterator means;
a writer means for deleting the selected element within the data structure wherein the writer means is configured to use the spinlock means to lock the data structure while adjusting those iterator means currently pointing to the selected element to avoid a dangling pointer.

32. The system of claim 31 further comprising:
a plurality of back pointer means for pointing to the iterator means wherein each back pointer means is associated with the element of the data structure and points back at the iterator means currently pointing to the element.

33. An article of manufacture, comprising:
a computer usable medium having computer readable program code means embodied therein for providing efficient shared access to a data structure having an ordered arrangement of elements, the computer readable program code means in the article of manufacture comprising:
computer readable program code for associating a spinlock with the data structure;
computer readable program code for defining a plurality of traversal iterators, each having a read pointer pointing to an element within the data structure, wherein each traversal iterator is associated with a reader task;
computer readable program code for traversing the data structure using the reader task, wherein the reader task holds the spinlock while using the read pointer of its associated traversal iterator; and
computer readable program code for deleting a selected element from the data structure using a writer task, wherein the writer task holds the spinlock while adjusting the read pointer of traversal iterators whose read pointers point to the selected element.

34. An article of manufacture as in claim 33, further comprising,
a computer readable program code means configured for defining a back pointer, wherein a referenced element has the back pointer pointing back to the traversal iterator; and
a computer readable program code means configured for deleting the selected element from the data structure using the writer task, wherein the writer task holds the spinlock while adjusting the read pointer of traversal iterators pointed to by the back pointer of the selected element being deleted.
